(19) United States
(12) Patent Application Publication
(10) Pub. No.: US 2004/0233590 A1
(43) Pub. Date: Nov. 25, 2004

(54) Inverter power supply device

(76) Inventors: Masanori Nakagawa, Numazu-shi (JP); Masahiko Endou, Numazu-shi (JP); Katsumi Yamamoto, Numazu-shi (JP); Kaoru Shinba, Numazu-shi (JP); Yoshihiro Sugisawa, Numazu-shi (JP)

Correspondence Address: PEARNE & GORDON LLP, 1801 EAST 9TH STREET, SUITE 1200, CLEVELAND, OH, 44114-3108, US

(21) Appl. No.: 10/848,683

(22) Filed: May 19, 2004

(30) Foreign Application Priority Data
May 20, 2003 (JP) 2003-142034

(51) Int. Cl. H02H 7/00

(52) U.S. Cl. 361/18

(57) ABSTRACT

An inverter power supply device having first and second inverter units operated in series or parallel operation, and a controller to control said inverter units, wherein one output terminal of the first inverter unit is connected to one output terminal of the second inverter unit, and another output terminal of the first inverter unit and another output terminal of the second inverter unit are connected to high-voltage-load connection terminals, the one output terminal and the other output terminal of one of the inverter units are connected to one and the other of low-voltage-load connection terminals, a switch is connected between the high-voltage-load connection terminals, and said controller controls said inverter units so that outputs of said units are added together in phase and applied between the high-voltage-load connection terminals when said switch is turned off, and the outputs of said units are added together in phase and applied between the low-voltage-load connection terminals when said switch is turned on.

### TECHNICAL FIELD OF THE INVENTION

The present invention relates to an inverter power supply device which supplies power to loads from two inverter units connected in series or in parallel with each other.

### BACKGROUND OF THE INVENTION

There has been widely used, as a power supply device for generating an AC output of a commercial frequency, an inverter power supply device which converts a direct current into an alternating current of a desired frequency and supplies the alternating current to a load. This kind of power supply device is comprised of, for example, a three-phase AC generator driven by an engine, a converter which converts AC output voltages output from the generator into a DC voltage, and an inverter unit which converts an AC output of a commercial frequency and supplies the AC output to a load.

An output frequency of utility power differs with districts, such as 50 Hz in some districts and 60 Hz in others. The rated voltage of utility power varies in the range from 100 [V] to 240 [V] among districts. In some cases, there is a need to drive loads varying in frequency and/or rated voltage even in one district.

In a case where an inverter power supply device which generates an output of a frequency corresponding to the commercial frequency is manufactured, different specifications may be prepared in correspondence with different rated frequencies and different rated voltages. However, from the viewpoint of enabling selection of the frequency and rated voltage while reducing the manufacturing cost, it is desirable to adapt one power supply device which can be adopted in each of different frequencies and voltages.

In an inverter power supply device, since an AC output voltage from a generator is converted into a DC voltage, and then, the DC voltage is re-converted into an alternating current by an inverter unit, different frequencies, but in same rated voltage, can be adopted only by changing the output frequency of the inverter unit by means of a mode switch.

However, if rated voltages differ, changing only the control of the inverter unit does not suffice because it is necessary to change the voltage input to the inverter unit.

For example, when drive of a load at a rated voltage of 120 [V] and drive of a load at a rated voltage of 240 [V] are enabled, it is necessary to input a voltage of 170 (=√2×120) [V] and a voltage of 340 (=√2×240) [V] to the inverter unit to enable the inverter unit to output these voltages. In such a case, if the rated output power is constant (for example, if the rated maximum instantaneous power=1700 [VA]), a generator having an output voltage versus output current characteristic indicated by A in FIG. 7 and a generator having an output voltage versus output current characteristic indicated by B in FIG. 7 are ordinarily prepared and are selectively connected according to the rated voltage. In such a case, if the power supply device is arranged to satisfy the output requirements by using one generator, it is necessary to use a generator having a characteristic indicated by C in FIG. 7 which is capable of outputting higher power in comparison with the generators having the characteristics A and B shown in FIG. 7. That is, a larger generator is required and the size of the power supply device is increased, resulting in an increase in manufacturing cost of the power supply device.

In the case of the above-described arrangement using one generator for 120 [V] and 240 [V], there is a need to use, as rectifier elements comprising the converter, switching elements comprising the inverter unit, or the like, circuit elements capable of withstanding a current flowing when the rated voltage is 120 [V] and a voltage applied when the rated voltage is 240 [V]. That is, there is a need to use circuit elements of rated power approximately twice that of circuit elements in a case where the generator for 120 [V] having the characteristic A shown in FIG. 7 or the generator for 240 [V] having the characteristic B shown in FIG. 7 is singly used. Therefore an increase in size of each of the converter and the inverter unit and an increase in manufacturing cost are unavoidable.

An inverter power supply device has been proposed in which a switching of parallel and series connections of two inverter units is selectively made to supply two AC outputs of different rated voltages to loads, as disclosed in Japanese Patent Application Laid-Open Publication No. 2000-217398.

FIG. 8 schematically shows the construction of a conventional power supply device of this kind. In FIG. 8, G and G′ respectively denote first and second generating coils which are provided in one magneto generator driven by an engine and which generate AC outputs; CNV and CNV′ respectively denote first and second converters which convert AC voltages output from the generating coils G and G′ into DC voltages; and IN and IN′ respectively denote first and second inverter units which convert DC outputs from the first and second converters CNV and CNV′ into AC outputs of a commercial frequency.

The inverter units IN and IN′ respectively comprise well-known bridge-type inverters INV and INV′ each comprising a switching element and a feedback diode in correspondence with each side of the bridge, and filters FL and FL′ which generate AC outputs having a sine waveform by removing harmonic components from AC outputs respectively obtained from the inverters INV and INV′.

Also in FIG. 8, CNT denotes a control section which controls on/off states of switching elements of the inverters INV and INV′ so that AC outputs V1 and V2 equal in magnitude (an effective value of 120V in this example) and in phase with each other are generated from the inverter units IN and IN′, and MSW denotes a mode switch for switching the output frequency of the inverter units between 50 Hz and 60 Hz.

Further, t11 and t12 denote a pair of high-voltage-load connection terminals to which a load LD1 of 240 [V] is connected, t21 and t22 denote a pair of low-voltage-load connection terminals to which a load LD2 of 120 [V] is connected, and SW denotes a series/parallel switching circuit which switches between a state in which the output sides of the inverter units IN and IN′ are connected in series with each other and a state in which the output sides of the inverter units IN and IN′ are connected in parallel with each other. The illustrated series/parallel switching circuit comprises switches S1 and S2 which are turned on when the output side of the inverter unit IN and the output side of the inverter unit IN′ are connected in series with each other, and which are turned off when the output sides of the both inverter units are connected in parallel with each other, and switches S3 to S5 which are turned on when the output side of the inverter unit IN and the output side of the inverter unit IN′ are connected in parallel with each other, and which are turned off when the output sides of the both inverter units are connected in series with each other.

In the illustrated example, each of the high-voltage-load connection terminals t11 and t12 and the low-voltage-load connection terminals t21 and t22 are formed of contacts provided in a first socket CT1 and a second socket CT2. The high-voltage load LD1 and the low-voltage load LD2 are connected to these sockets by means of plugs PL1 and PL2.

In the power supply device shown in FIG. 8, the output sides of the inverter units IN and IN′ are connected in series when the switches S1 and S2 are turned on while the switches S3 to S5 are turned off. An output voltage V3=V1+V2 (=240 V) which is the sum of the output voltage V1 (=120 V) and the output voltage V2 (=120 V) of the both inverter units is thereby applied between the high-voltage-load connection terminals till and t12.

Also, the output sides of the inverter units IN and IN′ are connected in parallel with each other when the switches S1 and S2 are turned off while the switches S3 to S5 are turned on. An output voltage V4=V1=V2 (=120 V) of the two inverter units is thereby applied between the low-voltage-load connection terminals t21 and t22.

As shown in FIG. 8, a number of switches (five switches in the example shown in FIG. 8) are required to form the series/parallel switching circuit SW in the conventional power supply device in which parallel and series connections of two inverter units are selectively made to obtain two voltages. Therefore, an increase in size and an increase in manufacturing cost of the power supply device are unavoidable.

### SUMMARY OF THE INVENTION

It is, therefore, an object of the present invention to provide an inverter power supply device in which a series/parallel switching circuit for switching between a state in which two inverter units are connected in series with each other and a state in which the two inverter units are connected in parallel with each other can comprise by one switch.

The present invention is applied to an inverter power supply device having first and second inverter units each of which converts a DC voltage into a single-phase AC voltage, a series/parallel switching circuit which switches between a state in which the output sides of the both inverter units are connected in series with each other between a pair of high-voltage-load connection terminals and a state in which the output sides of the two inverter units are connected in parallel with each other between a pair of low-voltage-load connection terminals, and a control section which controls the first and second inverter units.

According to the present invention, one output terminal of the first inverter unit and one output terminal of the second inverter unit are connected to each other, and another output terminal of the first inverter unit and another output terminal of the second inverter unit are respectively connected to one and the other of the pair of high-voltage-load connection terminals. Also, the one output terminal and the other output terminal of one of the first and second inverter units are respectively connected to one and the other of the pair of low-voltage-load connection terminals. A single series/parallel selection switch which is set in one of an on state and an off state is connected between the pair of high-voltage-load connection terminals. The single series/parallel selection switch comprises the series/parallel switching circuit.

The control section is arranged to control the first and second inverter units so that a phase of an output voltage of the first inverter unit as seen from the side of the one output terminal of the first inverter unit and a phase of an output voltage of the second inverter unit as seen from the side of the one output terminal of the second inverter unit are 180° out of phase with each other when the series/parallel selection switch is in the off state, and so that the phase of the output voltage of the first inverter unit as seen from the side of the one output terminal of the first inverter unit and the phase of the output voltage of the second inverter unit as seen from the side of the one output terminal of the second inverter unit are in phase with each other when the series/parallel selection switch is in the on state.

In the above-described arrangement, the output side of the first inverter unit and the output side of the second inverter unit are connected in series with each other by turning off the series/parallel selection switch to apply the output voltages of the two inverter units in a state of being added together in phase with each other between the high-voltage-load connection terminals. Also, the output side of the first inverter unit and the output side of the second inverter unit are connected in parallel with each other by turning on the series/parallel selection switch to apply the output voltages of the two inverter units in phase with each other between the low-voltage-load connection terminals.

In the above-described arrangement, the series/parallel switching circuit can comprise a single switch which performs on/off operation. Therefore, the inverter power supply device of the present invention can be simplified in construction, reduced in size and manufactured at a lower cost in comparison with the conventional inverter power supply device of this kind that requires a larger number of switches comprising a series/parallel switching circuit.

A DC power supply section which input DC voltages to the inverter units may be comprised of an AC generator driven by an engine or the like and a converter (including a rectifier or the like) which converts an output from the generator into a direct current, or may be arranged in such a manner that an output from a commercial power source system is converted into a DC output by a converter. Also, a battery may be used as the DC power supply section.

### BRIEF DESCRIPTION OF THE DRAWINGS

The above and other objects and features of the present invention will be apparent from the detailed description of the preferred embodiments of the invention, which is described and illustrated with reference to the accompanying drawings, in which;

FIG. 1 is a circuit diagram showing the construction of an embodiment of the present invention;

FIGS. 2A to 2H are waveform diagrams schematically showing the waveforms of drive signals supplied from a control section to inverters in a case where two inverter units are driven in a state of being connected in series in the embodiment shown in FIG. 1;

FIGS. 3A to 3C are waveform diagrams showing the waveforms of the voltages obtained from the two inverter units and the waveform of the voltage obtained between high-voltage-load connection terminals in a case where the two inverter units are driven in a state of being connected in series in the embodiment shown in FIG. 1;

FIGS. 4A to 4H are waveform diagrams schematically showing the waveforms of drive signals supplied from the control section to the inverters in a case where the two inverter units are driven in a state of being connected in parallel with each other in the embodiment shown in FIG. 1;

FIGS. 5A to 5C are waveform diagrams showing the waveforms of the voltages obtained from the two inverter units and the waveform of the voltage obtained between low-voltage-load connection terminals in a case where the two inverter units are driven in a state of being connected in parallel with each other in the embodiment shown in FIG. 1;

FIG. 6 is a circuit diagram showing the construction of another embodiment of the present invention;

FIG. 7 is a graph showing various output characteristics required of generators in a case where the generators are used as a power supply for an inverter power supply device; and

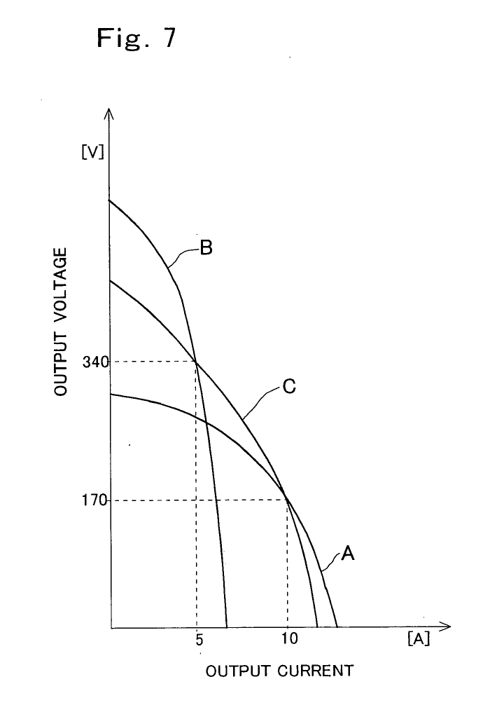

FIG. 8 is a circuit diagram schematically showing the construction of a conventional inverter power supply device.

### DETAILED DESCRIPTION OF THE PREFERRED EMBODIMENTS

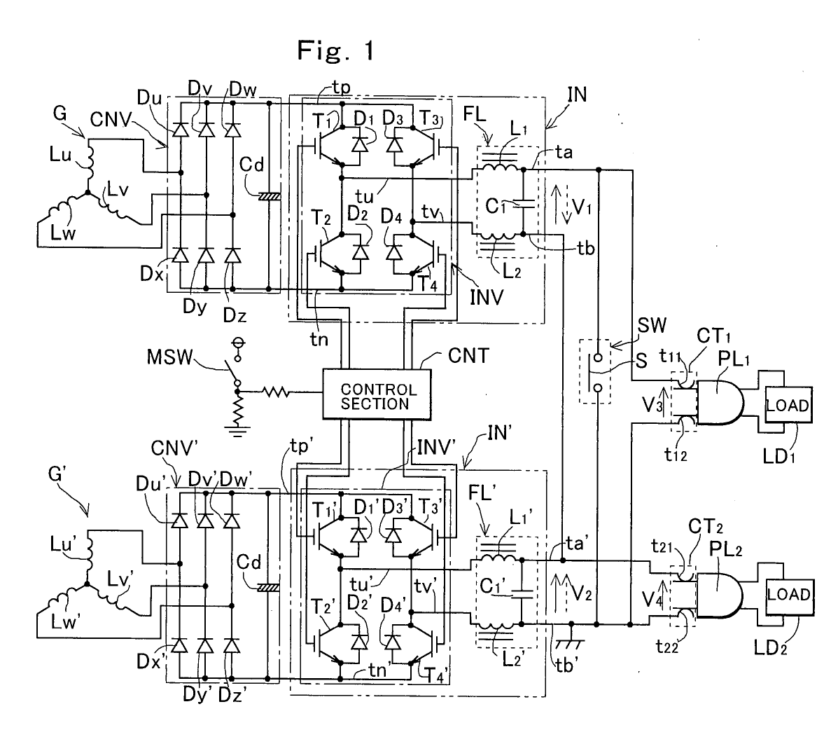

Embodiments of the present invention will be described with reference to FIGS. 1 to 6.

FIG. 1 shows an embodiment of the present invention. In FIG. 1, G and G′ respectively denote first and second generating coils which are provided in an AC generator driven by an engine and which generate AC outputs, and CNV and CNV′ respectively denote first and second converters which convert the AC outputs from the generating coils G and G′ into DC outputs. The generating coils G and G′ and the converters CNV and CNV′ form a power supply section which outputs DC voltages. IN denotes a first inverter unit which comprises an inverter INV and a filter FL and which converts the DC output from the first converter CNV into an AC output of a commercial frequency, and IN′ denotes a second inverter unit which comprises an inverter INV′ and a filter FL′ and which converts the DC output from the second converter CNV′ into an AC output of a commercial frequency. CNT denotes a control section which controls the on/off states of switching elements of the inverters INV and INV′. MSW denotes a mode switch which sends to the control section CNT a command for switching of the output frequency of the inverter units IN and IN′ between 50 Hz and 60 Hz.

The first and second generating coils G and G′ respectively comprise a group of three-phase coils Lu, Lv, and Lw in a star connection and a group of three-phase coils Lu′, Lv′, and Lw′ in a star connection, and output three-phase AC voltages with the rotation of the engine.

The converter CNV has a diode-bridge full-wave rectifying circuit comprising diodes Du, Dv, and Dw, and diodes Dx, Dy, and Dz, and a smoothing capacitor Cd connected between DC output terminals of this rectifying circuit.

Similarly, the converter CNV′ has a diode-bridge full-wave rectifying circuit formed by diodes Du′, Dv′, and Dw′, and diodes Dx′, Dy′, and Dz′, and a smoothing capacitor Cd′ connected between DC output terminals of this rectifying circuit.

The inverter INV has a bridge-type switch circuit having switching elements T1 to T4 comprising four sides of an H bridge, and feedback diodes D1 to D4 connected in an inverse parallel relationship with the switching elements T1 to T4. In the illustrated embodiment, an IGBT (insulated gate bipolar transistor) is used as each of the switching elements T1 to T4, and the DC voltage obtained from the converter CNV is applied between DC input terminals tp and tn of the inverter INV.

Similarly, the inverter INV′ has a bridge-type switch circuit having switching elements T1′ to T4′ comprising four sides of an H bridge, and feedback diodes D1′ to D4′ connected in an inverse parallel relationship with the switching elements T1′ to T4′. The DC voltage from the converter CNV′ is applied between DC input terminals tp′ and tn′ of the inverter INV′.

The filter circuit FL is a low-pass filter formed by coils L1 and L2 and a capacitor C1. The filter circuit FL removes harmonics contained in the AC voltage obtained between AC output terminals tu and tv of the inverter INV and outputs AC voltage V1 having a sine waveform between output terminals ta and tb of the inverter unit IN.

Similarly, the filter circuit FL′ is a low-pass filter formed by coils L1′ and L2′ and a capacitor C1′. The filter circuit FL′ removes harmonics contained in the AC voltage obtained between AC output terminals tu′ and tv′ of the inverter INV′ and outputs AC voltage V2 having a sine waveform between output terminals ta′ and tb′ of the inverter unit IN′.

In the present invention, one output terminal tb of the first inverter unit IN and one output terminal ta′ of the second inverter unit IN′ are directly connected to each other, and the other output terminal ta of the first inverter unit IN and the other output terminal tb′ of the second inverter unit IN′ are respectively connected directly to one t11 and the other t12 of the pair of high-voltage-load connection terminals. Also, the two output terminals of one of the first and second inverter units IN and IN′(the inverter unit IN′ in the illustrated embodiment) are respectively connected directly to one t21 and the other t22 of the pair of low-voltage-load connection terminals. Further, a single series/parallel selection switch S for setting an on/off state is connected between the pair of high-voltage-load connection terminals till and t12. This series/parallel selection switch S comprises a series/parallel switching circuit SW.

In the illustrated embodiment, each of the pair of high-voltage-load connection terminals t11 and t12 and the pair of low-voltage-load connection terminals t21 and t22 are formed of contacts provided in one of a first socket CT1 and a second socket CT2. A high-voltage load LD1 and a low-voltage load LD2 are connected to these sockets by means of plugs PL1 and PL2.

The control section CNT is arranged to control the first and second inverter units IN and IN′ so that the phase of the output voltage V1 of the first inverter unit IN as seen from the side of one output terminal tb of the first inverter unit IN and the phase of the output voltage V2 of the second inverter unit IN′ as seen from the side of one output terminal ta′ of the second inverter unit IN′ directly connected to the output terminal tb are 180° out of phase with each other when the series/parallel selection switch S is in the off state, and so that the phase of the output voltage V1 of the first inverter unit IN as seen from the side of one output terminal tb of the first inverter unit IN and the phase of the output voltage V2 of the second inverter unit IN′ as seen from the side of one output terminal ta′ of the second inverter unit IN′ are in phase with each other when the series/parallel selection switch S is in the on state.

That is, the control section CNT controls the inverter units IN and IN′ so that the output voltage V1 of the first inverter unit IN and the output voltage V2 of the second inverter unit IN′ are applied between the high-voltage-load connection terminals t11 and t12 in a state of being added together in phase with each other when the series/parallel selection switch S is in the off state, and so that the output voltage V1 of the first inverter unit IN and the output voltage V2 of the second inverter unit IN′ are applied between the low-voltage-load connection terminals t21 and t22 in phase with each other when the series/parallel selection switch S is in the on state.

To perform control as described above in the embodiment shown in FIG. 1, the inverters INV and INV′ of the two inverter units IN and IN′ may be controlled so that the AC voltages V1 and V2 in phase with each other are respectively output from the two inverter units IN, IN′ as indicated by solid line arrows in FIG. 1 when the series/parallel selection switch S is in the off state, and so that the AC voltages V1 and V2 in phase opposition to each other (180° out of phase with other) are respectively output from the two inverter units IN, IN′ as indicated by broken line arrows in FIG. 1 when the series/parallel selection switch S is in the on state.

Also, the control section CNT switches the output frequency of the inverters according to the state of the mode switch so that the output frequency of the inverters INV and INV′ is set to 50 Hz, for example, when the mode switch MSW is open, and so that the output frequency of the inverters INV and INV′ is set to 60 Hz when the mode switch MSW is closed.

In this embodiment, the control section CNT performs control so that the peak value of the output voltage V1 of the inverter unit IN and the peak value of the output voltage V2 of the inverter unit IN′ are equal to each other at all times.

In the above-described arrangement, the output side of the first inverter unit IN and the output side of the second inverter unit IN′ are connected in series with each other by turning off the series/parallel selection switch S to apply the output voltages V1 and V2 of the two inverter units in a state of being added together in phase with each other as a voltage V3 between the high-voltage-load connection terminals t11 and t12. Also, the output side of the first inverter unit IN and the output side of the second inverter unit IN′ are connected in parallel with each other by turning on the series/parallel selection switch S to apply the output voltages V1 and V2 of the two inverter units in phase with each other between the low-voltage-load connection terminals t21 and t22. At this time, if the voltage applied between the low-voltage-load connection terminals is V4, V4=V1=V2.

When the series/parallel selection switch S is in the on state, a short circuit is established between the high-voltage-load connection terminals t11 and t12 by the switch S. In this state, therefore, no voltage appears between the high-voltage-load connection terminals t11 and t12.

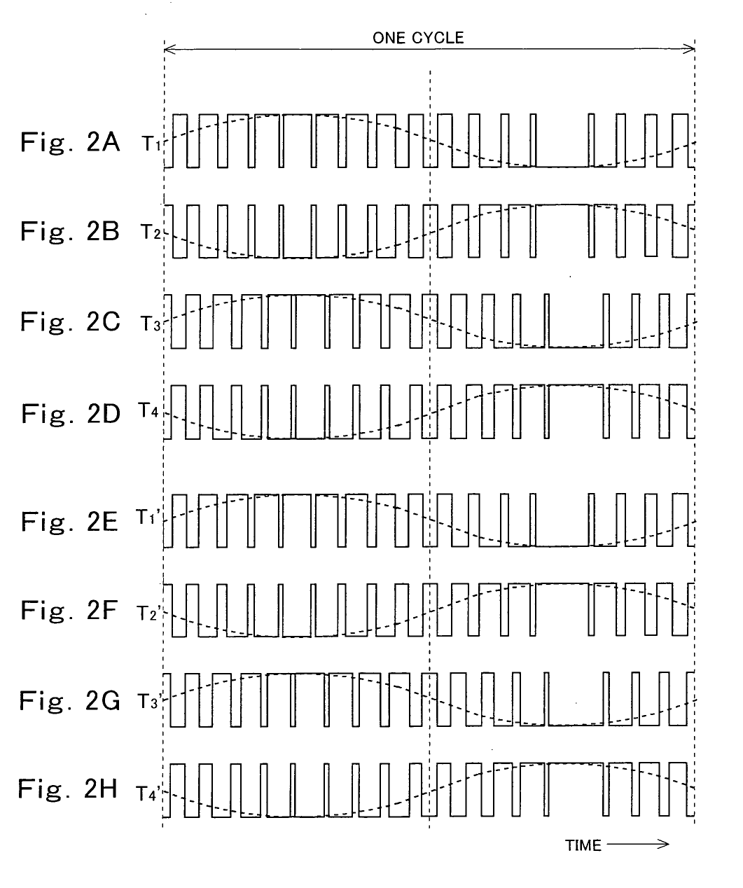

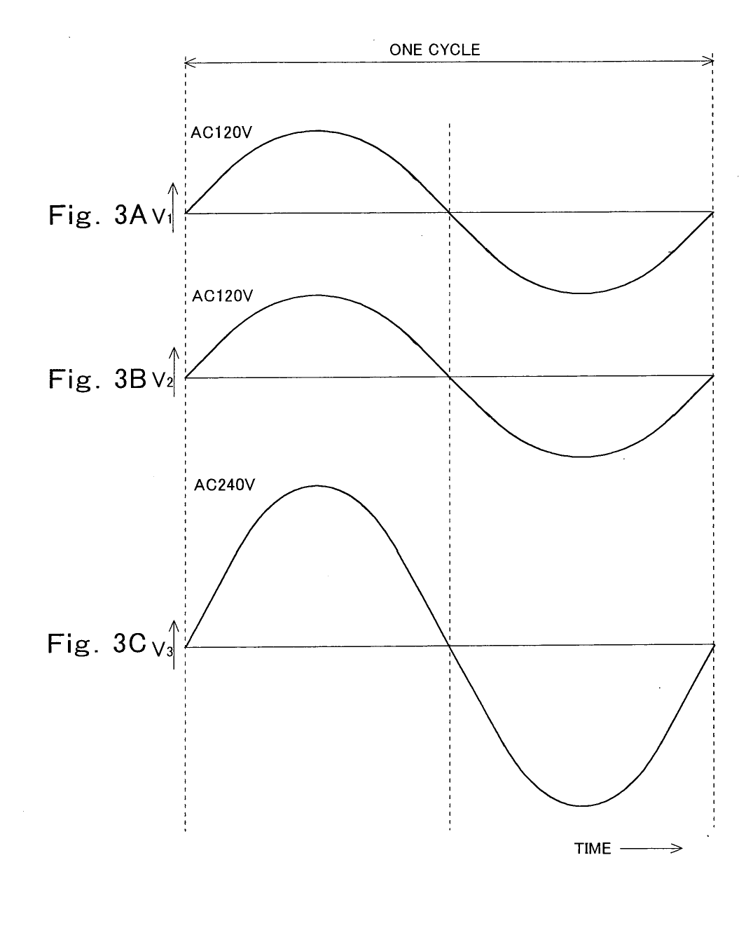

FIGS. 2A to 2D are waveform diagrams schematically showing an example of the waveforms of drive signals supplied from the control section CNT to the switching elements T1 to T4 of the inverter INV when the series/parallel selection switch S is in the off state in the embodiment shown in FIG. 1, and FIGS. 2E to 2H are waveform diagrams schematically showing an example of the waveforms of drive signals supplied from the control section CNT to the switching elements T1′ to T4′ of the inverter INV′ when the series/parallel selection switch S is in the off state (at the time of series connection). FIGS. 3A and 3B show the waveforms of the AC voltages V1 and V2 respectively output from the inverter units IN and IN′ at this time, and FIG. 3C shows the waveform of the AC voltage V3 obtained between the high-voltage-load connection terminals t11 and t12.

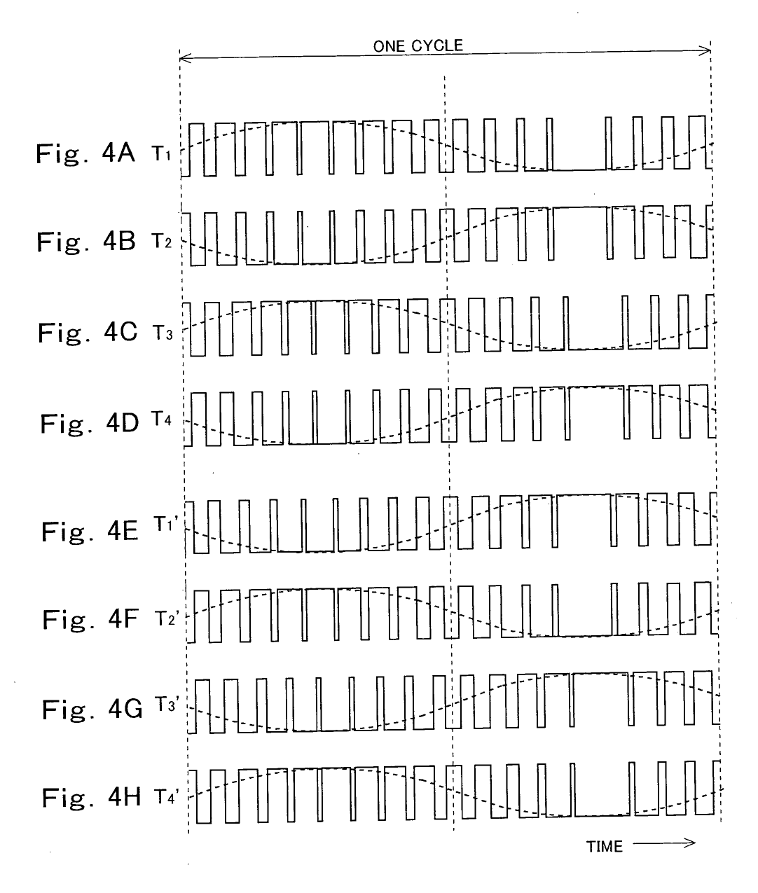

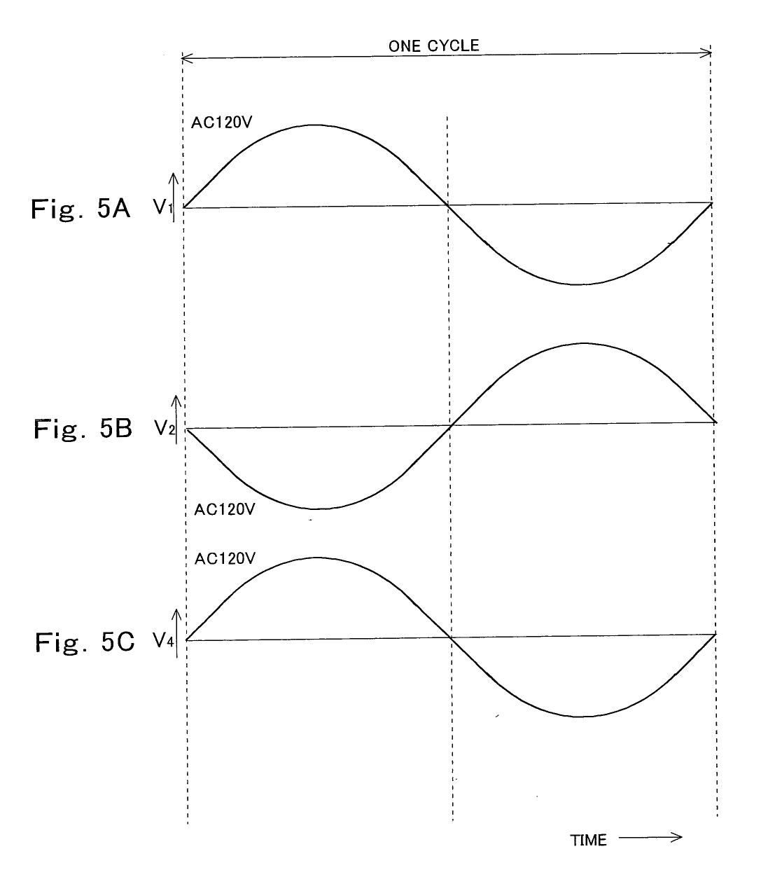

FIGS. 4A to 4D are waveform diagrams schematically showing an example of the waveforms of drive signals supplied from the control section CNT to the switching elements T1 to T4 of the inverter INV when the series/parallel selection switch S is in the on state (at the time of parallel connection) in the embodiment shown in FIG. 1, and FIGS. 4E to 4H are waveform diagrams schematically showing an example of the waveforms of drive signals supplied from the control section CNT to the switching elements T1′ to T4′ of the inverter INV′ when the series/parallel selection switch S is in the on state. FIGS. 5A and 5B show the waveforms of the AC voltages V1 and V2 respectively output from the inverter units IN and IN′ at this time, and FIG. 5C shows the waveform of the AC voltage V4 obtained between the low-voltage-load connection terminals t11 and t12.

In the above-described arrangement, the series/parallel switching circuit SW can comprise a single switch S which performs on/off operation. Consequently, the inverter power supply device of the present invention can be simplified in construction, reduced in size and manufactured at a lower cost in comparison with the conventional inverter power supply device of this kind that requires a larger number of switches comprising a series/parallel switching circuit.

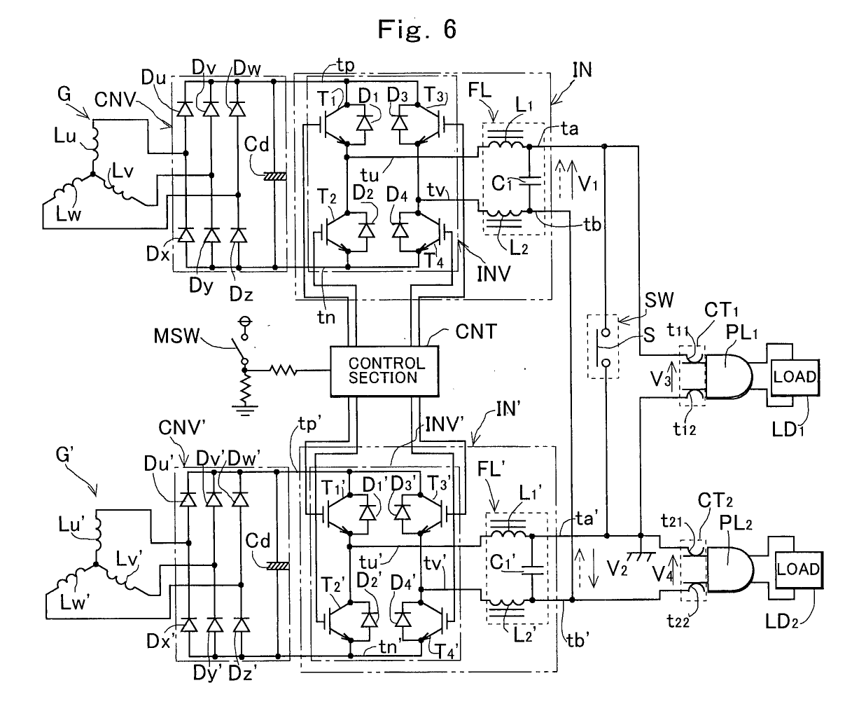

In the above-described embodiment, one output terminal of the first inverter unit IN, i.e., the output terminal tb in the output terminals ta and tb, and one output terminal of the second inverter unit IN′, i.e., the output terminal ta′ in the output terminals ta′ and tb′, are directly connected to each other. However, the present invention is not limited to this arrangement. For example, one output terminal tb of the first inverter unit IN and one output terminal tb′ of the second inverter unit IN′ may be directly connected to each other, as shown in FIG. 6. Also in this case, the series/parallel selection switch S is connected between the other output terminal ta of the first inverter unit IN and the other output terminal ta′ of the second inverter unit IN′, and the other output terminal ta of the first inverter unit IN and the other output terminal ta′ of the second inverter unit IN′ are respectively connected directly to one and the other of the pair of high-voltage-load connection terminals.

Also in the case of the construction shown in FIG. 6, the control section CNT is arranged to control the first and second inverter units IN and IN′ so that the phase of the output voltage V1 of the first inverter unit IN as seen from the side of one output terminal tb of the first inverter unit IN and the phase of the output voltage V2 of the second inverter unit IN′ as seen from the side of one output terminal tb′ of the second inverter unit IN′ are 180° out of phase with each other when the series/parallel selection switch S is in the off state, and so that the phase of the output voltage V1 of the first inverter unit IN as seen from the side of one output terminal tb of the first inverter unit IN and the phase of the output voltage V2 of the second inverter unit IN′ as seen from the side of one output terminal tb′ of the second inverter unit IN′ are in phase with each other when the series/parallel selection switch S is in the on state.

In this arrangement, the voltage V3=V1+V2 obtained by adding together the output voltages V1 and V2 of the inverter units IN and IN′ in an in-phase state can be applied between the high-voltage-load connection terminals when the series/parallel selection switch S is in the off state (at the time of series connection), and the output voltages V1 and V2 of the inverter units IN and IN′ can be applied in phase between the low-voltage-load connection terminals when the series/parallel selection switch S is in the on state (at the time of parallel connection).

The present invention can also be implemented in such a manner that one output terminal of the first inverter unit IN connected as described above is the output terminal ta of the first inverter unit IN and one output terminal of the second inverter unit IN′ connected as described above is the output terminal ta′ or tb′ of the second inverter unit IN′.

While in the above-described embodiments the generating coils G and G′ are provided in a common generator, these coils may alternatively be provided in different generators. While in the above-described embodiments each of the generating coils G and G′ has a three-phase configuration, the present invention can of course be applied to an arrangement using single-phase generating coils.

In the above-described embodiments, the power supply section which outputs DC voltages is formed by generating coils provided in an AC generator driven by an engine and converters which convert the output voltages of the generating coils into DC voltages, output voltages of the AC generator are thereby converted into DC voltages, and the DC voltages are converted into AC voltages by inverters. However, the present invention can also be applied to an arrangement in which a power supply section includes a rectifier which rectifies an output from a commercial power system, and in which a DC voltage obtained from the power supply section is input to an inverter unit to be converted into an AC voltage.

Further, the power supply section from which DC voltages are supplied to the inverter units IN and IN′ may be a battery. That is, the power supply section in a stage before the inverter units IN and IN′ may be of any type if it outputs DC voltages.

The control section CNT may be formed so as to control the inverter units IN and IN′ by one controller, and may be formed so as to control the inverter units IN and IN′ while maintaining synchronization between the inverter units by another controller.

While in the above-described embodiments the converter CNV comprises by a diode-bridge full-wave rectifying circuit, it may alternatively comprise a control rectifying circuit in which a portion or the whole of the diode bridge is replaced with switching elements such as thyristors or FETs.

While in the above-described embodiments IGBTs are used as switching elements comprising the inverter, the inverter may be alternatively comprised by using bipolar transistors or FETs as switching elements.

The above-described series/parallel selection switch S may be a switch having mechanical contacts, e.g., a relay or an electromagnetic contact device, or a noncontact switch using a semiconductor switch.

While in the above-described embodiments the output frequency of the inverter units corresponds to the commercial frequency, it is not necessarily limited to the commercial frequency. For example, the present invention can also be applied to an arrangement in which the output from a commercial power system is temporarily converted into a direct current and is thereafter converted into a high-frequency output.

The control by the control section has been described by assuming that the peak values of the output voltages of the two inverter units IN and IN′ are maintained equal to each other at all times. However, the control by the control section may alternatively be performed so that the peak values of the output voltages of the two inverter units are equal to each other when the series/parallel selection switch S is in the on state, and the peak values of the output voltages of the two inverter units are different from each other when the series/parallel selection switch S is in the off state.

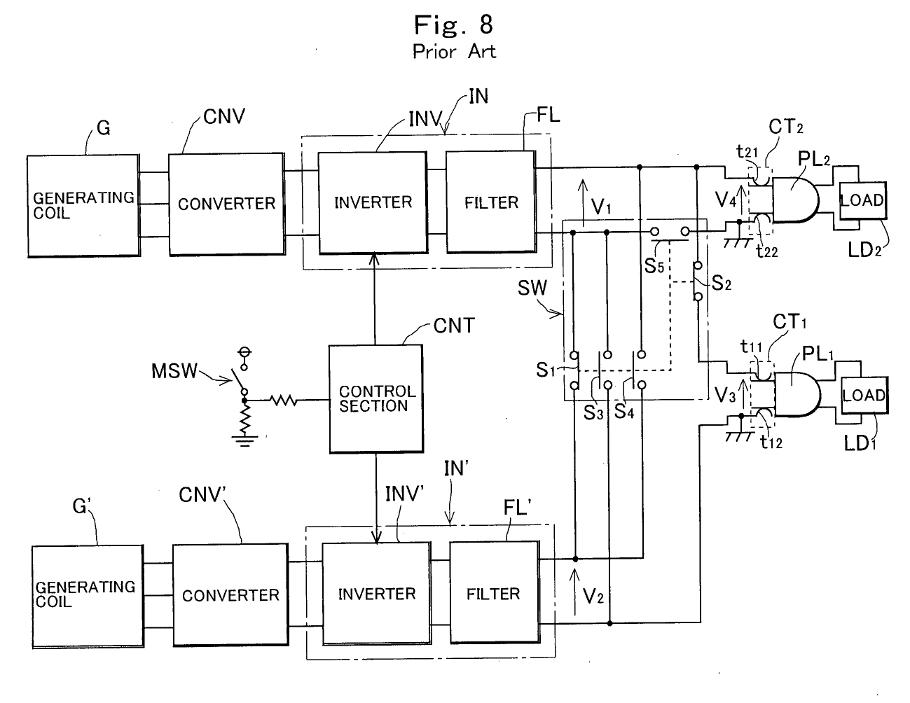

In the above-described embodiments, the low-voltage-load connection terminals t21 and t22 are directly connected to the output terminals ta′ and tb′ of the second inverter unit IN′. If there is a need to prevent output of any voltage between the low-voltage-load connection terminals at the time of high-voltage-load drive, a load opening/closing switch (a switch similar to the switch S5 shown in FIG. 8) may be inserted at at least one of the position between the low-voltage-load connection terminal t21 and the output terminal ta′ of the second inverter unit IN′ and the position between the low-voltage-load connection terminal t22 and the output terminal tb′ of the second inverter unit IN′.

The low-voltage-load connection terminals t21 and t22 may be connected to the first inverter unit IN side.

According to the present invention, as described above, a series/parallel switching circuit which switches between a state in which two inverters are connected in series with each other and a state in which the inverters are connected in parallel with each other can comprise a single switch performing on/off operation. Therefore the construction of the inverter power supply device of the present invention can be simplified in construction, reduced in size and manufactured at a reduced cost in comparison with the conventional inverter power supply device that requires a larger number of switches comprising a series/parallel switching circuit.

Although some preferred embodiments of the invention have been described and illustrated with reference to the accompanying drawings, it will be understood by those skilled in the art that they are by way of examples, and that various changes and modifications may be made without departing from the spirit and scope of the invention, which is defined only to the appended claims.

What is claimed is:

1. An inverter power supply device comprising first and second inverter units each of which converts a DC voltage into a single-phase AC voltage, a series/parallel switching circuit which switches between a state in which the output sides of the two inverter units are connected in series with each other between a pair of high-voltage-load connection terminals and a state in which the output sides of the two inverter units are connected in parallel with each other between a pair of low-voltage-load connection terminals, and a control section which controls said first and second inverter units,
wherein one output terminal of said first inverter unit and one output terminal of said second inverter unit are connected to each other,
wherein another output terminal of said first inverter unit and another output terminal of said second inverter unit are respectively connected to one and the other of said pair of high-voltage-load connection terminals,
wherein the one output terminal and the other output terminal of one of said first and second inverter units are respectively connected to one and the other of said pair of low-voltage-load connection terminals,
wherein said series/parallel switching circuit is formed by a single series/parallel selection switch which is connected between said pair of high-voltage-load connection terminals and which is set in one of an on state and an off state, and
wherein said control section is constructed to control said first and second inverter units so that the phase of an output voltage of said first inverter unit as seen from the side of the one output terminal of said first inverter unit and the phase of an output voltage of said second inverter unit as seen from the side of the one output terminal of said second inverter unit are 180° out of phase with each other when said series/parallel selection switch is in the off state, and so that the phase of the output voltage of said first inverter unit as seen from the side of the one output terminal of said first inverter unit and the phase of the output voltage of said second inverter unit as seen from the side of the one output terminal of said second inverter unit are in phase with each other when said series/parallel selection switch is in the on state.

2. The inverter power supply device according to claim 1, wherein said control section performs control so that a peak value of the output voltage of said first inverter unit and a peak value of the output voltage of said second inverter unit are equal to each other at all times.

3. The inverter power supply device according to claim 1, wherein said control section performs control so that a peak value of the output voltage of said first inverter unit and a peak value of the output voltage of said second inverter unit are equal to each other when said series/parallel selection switch is in the on state, and so that the peak values of the two inverter units are different from each other when said series/parallel selection switch is in the off state.

4. An inverter power supply device comprising a power supply section which outputs DC voltages, first and second inverter units which convert the DC voltages into single-phase AC voltages, a series/parallel switching circuit which switches between a state in which the output sides of the two inverter units are connected in series with each other between a pair of high-voltage-load connection terminals and a state in which the output sides of the two inverter units are connected in parallel with each other between a pair of low-voltage-load connection terminals, and a control section which controls said first and second inverter units,
wherein one output terminal of said first inverter unit and one output terminal of said second inverter unit are connected to each other,
wherein another output terminal of said first inverter unit and another output terminal of said second inverter unit are respectively connected to one and the other of said pair of high-voltage-load connection terminals,
wherein the one output terminal and the other output terminal of one of said first and second inverter units are respectively connected to one and the other of said pair of low-voltage-load connection terminals,
wherein said series/parallel switching circuit is formed by a single series/parallel selection switch which is connected between said pair of high-voltage-load connection terminals and which is set in one of an on state and an off state, and
wherein said control section is constructed to control said first and second inverter units so that the phase of an output voltage of said first inverter unit as seen from the side of the one output terminal of said first inverter unit and the phase of an output voltage of said second inverter unit as seen from the side of the one output terminal of said second inverter unit are 180° out of phase with each other when said series/parallel selection switch is in the off state, and so that the phase of the output voltage of said first inverter unit as seen from the side of the one output terminal of said first inverter unit and the phase of the output voltage of said second inverter unit as seen from the side of the one output terminal of said second inverter unit are in phase with each other when said series/parallel selection switch is in the on state.

5. The inverter power supply device according to claim 4, wherein said power supply section has first and second generating coils which are provided in an AC generator driven by an engine and which output AC voltages, and first and second converters which convert the AC voltages output from said first and second generating coils into DC voltages.

6. The inverter power supply device according to claim 4, wherein said power supply section is comprised of a rectifier which rectifies an output from a commercial power system.

7. The inverter power supply device according to claim 4, wherein said power supply section includes a battery.

8. The inverter power supply device according to claim 4, wherein said control section performs control so that a peak value of the output voltage of said first inverter unit and a peak value of the output voltage of said second inverter unit are equal to each other at all times.

9. The inverter power supply device according to claim 4, wherein said control section performs control so that a peak value of the output voltage of said first inverter unit and a peak value of the output voltage of said second inverter unit are equal to each other when said series/parallel selection switch is in the on state, and so that the peak values of the two inverter units are different from each other when said series/parallel selection switch is in the off state.
